(19) United States
(12) Patent Application Publication
(10) Pub. No.: US 2008/0083427 A1
(43) Pub. Date: Apr. 10, 2008

(54) POST ETCH RESIDUE REMOVAL FROM SUBSTRATES

(75) Inventors: Joy Block, Kalispell, MT (US); Dana Scranton, Kalispell, MT (US); Craig Meuchel, Kalispell, MT (US)

Correspondence Address: PERKINS COIE LLP/SEMITOOL, PO BOX 1208, SEATTLE, WA, 98111-1208, US

(73) Assignee: Semitool, Inc., Kalispell, MT (US)

(21) Appl. No.: 11/869,096

(22) Filed: Oct. 9, 2007

Related U.S. Application Data
(60) Provisional application No. 60/828,763, filed on Oct. 9, 2006.

(51) Int. Cl. C23G 1/02; B08B 3/08

(52) U.S. Cl. 134/3; 134/56 R

(57) ABSTRACT

A method for removing residue from a workpiece includes preparing a liquid including de-ionized water, sulfuric acid, and optionally hydrofluoric acid. Carbon dioxide gas is provided into the liquid. The liquid is maintained at a desired temperature. The liquid is applied onto a workpiece in a process chamber. The liquid may be formed into a liquid layer on the workpiece having a controlled thickness. Ozone gas may be introduced into the chamber and chemically reacts with residue on the workpiece. In a second separate method the liquid includes de-ionized water, highly dilute hydrofluoric acid and carbon dioxide, with no need for ozone gas.

### PRIORITY CLAIM

This Application claims priority to U.S. Provisional Patent Application No. 60/828,763, filed Oct. 9, 2006, and incorporated herein by reference.

### BACKGROUND OF THE INVENTION

During manufacturing of microelectronic and similar devices, a substrate is typically etched to form desired patterns and features. Etching may be performed using liquids, gases or plasmas. The etching generally leaves a residue or polymer on the substrate. The residue must be removed before further processing, to avoid contamination and defects in the product devices formed on the substrate. The residue has conventionally been removed by using aqueous solutions containing acids and oxidizers. However, these techniques are not always necessarily highly effective in removing the residue. Accordingly, improved methods are needed for removing post etch residue from substrates.

### SUMMARY

A first method for removing residue from a substrate or workpiece having aluminum features or surfaces includes applying a process liquid onto the workpiece. The process liquid includes de-ionized water, sulfuric acid, hydrofluoric acid and carbon dioxide gas. The liquid is provided at a temperature of about 15-45° C. The liquid is formed into a liquid layer on the workpiece. The thickness of the liquid layer is controlled. Ozone gas is introduced into the process chamber and chemically reacts with residue on the workpiece, to clean the workpiece. The ozone gas may be entrained in the liquid, and/or diffuse through the liquid layer.

A second method for removing residue from a workpiece having aluminum or copper features or surfaces includes applying a process liquid onto the workpiece. The process liquid includes de-ionized water, dilute hydrofluoric acid, and carbon dioxide gas. The liquid is provided at a temperature of about 15-45° C.

The methods and apparatus described are highly effective in removing residue, such as post etch residue, from workpieces. The invention resides as well in sub-combinations of the elements and steps described.

### BRIEF DESCRIPTION OF THE DRAWINGS

In the drawings, the same element number indicates the same element, in each of the views.

FIG. 1 is a schematic diagram of a system for removing residue from a workpiece.

FIG. 2 is a perspective view of an automated system including elements shown in FIG. 1.

FIG. 3 is a plan view of the system shown in FIG. 2.

### DETAILED DESCRIPTION OF THE DRAWINGS

In a first embodiment of a process for removing post etch residue from a workpiece, such as a semiconductor wafer, having aluminum features or surfaces (such as lines, pads, etc.) includes applying a liquid onto the workpiece, with the liquid including de-ionized water, sulfuric acid, optionally with highly dilute hydrofluoric acid, and carbon dioxide. The sulfuric acid concentration may be from about 5-10% by volume (using 96 wt % sulfuric acid as the starting material). Typical sulfuric acid concentrations may be 6-8%, 7% or 7.5% by volume.

The hydrofluoric acid (HF), if used, may have a concentration ranging from 0-500 ppm (of 49 (weight) % HF concentration in water as provided by the HF manufacturer). HF concentrations of 20-300 ppm by weight may be more typical.

Carbon dioxide gas (CO2) is provided in the liquid. The CO2 may be injected into a supply line or a liquid recirculation line, or injected or bubbled into a vessel holding the liquid. Optionally the liquid may be saturated with CO2. If additional CO2 is provided beyond saturation, the bubbles of CO2 formed may be entrained in and carried along with the liquid. The CO2 is added to the liquid before the liquid is applied onto the workpiece.

The liquid, including the deionized water, sulfuric acid, and CO2, and optionally the HF, is formed into a thin layer of liquid on the wafer surface, for example as described in U.S. Pat. No. 6,869,487 or 09/925,884, both incorporated herein by reference. The wafer is generally rotated on a rotor or turntable within a process chamber, to help distribute the liquid and to provide a thin liquid layer. The liquid flow rate may be correspondingly adjusted. The liquid may be sprayed or jetted onto the wafer via nozzles, or provided in bulk onto the wafer from one or more liquid outlets. The process may be used in single wafer processing, or in batch processing. The thickness of the liquid layer is controlled by adjusting the flow rate of liquid onto the workpiece, and/or the spin speed. A process chamber as described in U.S. patent application Ser. Nos. 11/075,099 or 11/619,515, both incorporated herein by reference, may be used.

Ozone gas is provided into the process chamber. Some ozone gas then diffuses through the thin liquid layer and reacts with the residue, along with the sulfuric acid, and the HF, if used. The CO2 acts to reduce or prevent corrosion of the aluminum features. The ozone gas may alternatively, or supplementally be entrained in the liquid. When ozone is used, the ozone is supplied to provide a concentration in the chamber generally in the range of 75 GNM3 (gram normal cubic meter) to 300 GNM3 (or higher if available from the ozone gas generator).

The ozone gas may be sprayed onto the liquid layer. If the liquid and the ozone are both sprayed onto the wafer at the same time, some ozone gas may be entrained into the liquid spray and carried with the liquid spray onto the wafer.

The liquid temperature is generally set at about 20-40° C. or about 25-30° C. Heaters and/or chillers may be used to maintain the liquid at the desired temperature. Sulfuric acid mixed with water results in an exothermic reaction which can increase the liquid temperature above the desired temperature, such that chillers may be used in liquid temperature control, even in the 20-40 C range.

Use of sulfuric acid, HF and CO2 may not be sufficient on some types of residue. However, adding in ozone with the sulfuric acid and the HF and CO2 results in a process effective in removing many of these types of residues.

Typical process times run from about 30 seconds to about 3 minutes, and will vary with process parameters and types of residue. Running the process for much less than 30 seconds will often result in incomplete removal of the residue. Running the process for far more than 3 minutes may result in excessive attack of the aluminum features on the wafer. Following processing, the wafer may undergo an in-situ rinse and dry, for example as described in U.S. patent application Ser. No. 11/359,969, incorporated herein by reference.

In a second and separate alternative process, a solution for removing post etch residue includes DI water, dilute HF and CO2. The HF concentration is typically about 500:1 to about 2000:1 by volume (again starting with 49% HF by weight in water as provided by the HF manufacturer). CO2 is may be injected into the HF/water liquid solution, to saturation. The liquid temperature is controlled to remain at about 20-40 C. Most often the liquid temperature is about 25-30 C, or 26-28 C. Higher temperatures, e.g., above 30 or 40 C result in an etch rate that is generally too high for many applications. With some applications of this process, the results may be highly temperature dependent, with variations of even 1 or 2 degrees C. significantly affecting the outcome. Accordingly, in these applications, precise liquid temperature control is used. Process times generally are 30 seconds to about 3 minutes. These process times are significantly faster than existing processes using DI water and HF, without CO2.

Both processes may be run at about ambient pressure, with above or below ambient pressure optionally used in specific applications.

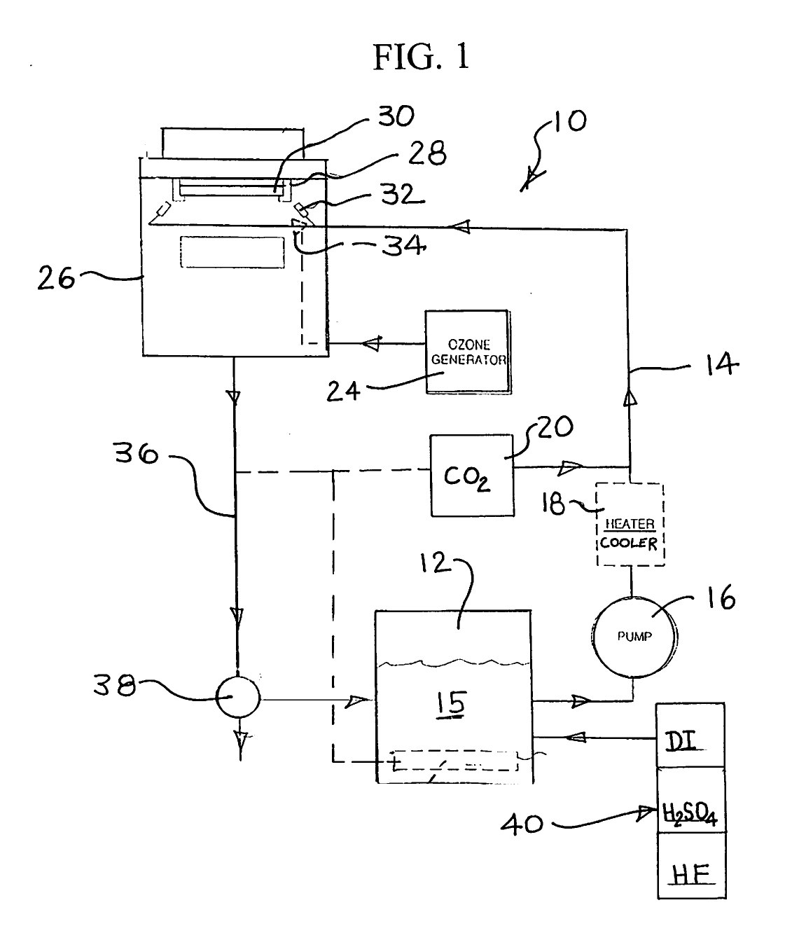

FIG. 1 is a schematic diagram of a system 10 which may be used to perform the methods described above. As shown in FIG. 1, de-ionized water, and the acid(s) used in the process (sulfuric acid, hydrofluoric acid, or both) are provided to the system from a source 40. They may be mixed before delivery, or mixed in a tank or vessel 12 included in the system 10. A pump moves the liquid 15 through a liquid supply line 14. The liquid 15 is heated or cooled, to maintain the liquid at the desired temperature, via an in line heater/cooler 18. Alternatively, an in tank heater/cooler may be used. Carbon dioxide gas is added to the liquid 15 from a tank or other source 20. Typically, the carbon dioxide gas is injected into the delivery line 14 after the heater/cooler 18. The carbonated liquid flows to liquid outlets or spray nozzles 32 within a process chamber 26. The outlets 32 are positioned to apply the liquid 15 onto a workpiece 30 on a rotor 30.

An ozone generator 24 supplies ozone into the chamber 26. The ozone may be jetted or sprayed onto the workpiece via ozone gas nozzles 34. The ozone may alternatively be entrained in the liquid 15, instead of being delivered into the chamber as a dry gas. Although FIG. 1 shows the outlets or nozzles spraying up (against gravity) onto the workpiece, the orientation may of course be inverted, with the rotor below the workpiece and the nozzles spraying down (with gravity) onto the workpiece. As shown in dotted lines in FIG. 1, the carbon dioxide may alternatively be added to the liquid 15 in the tank 15, or in the recirculation line 36, or even in the liquid chemical source 40. The rotor 28 may be adapted to hold a single workpiece or a batch of workpieces.

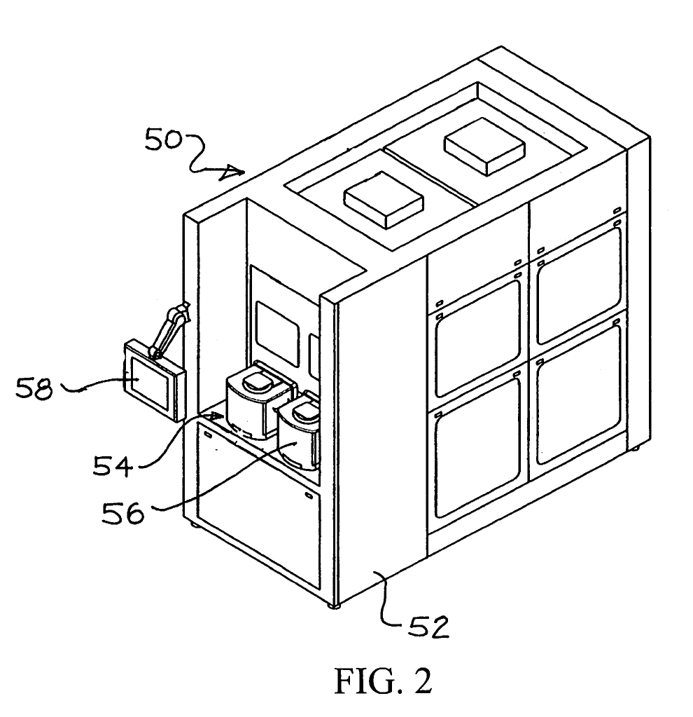

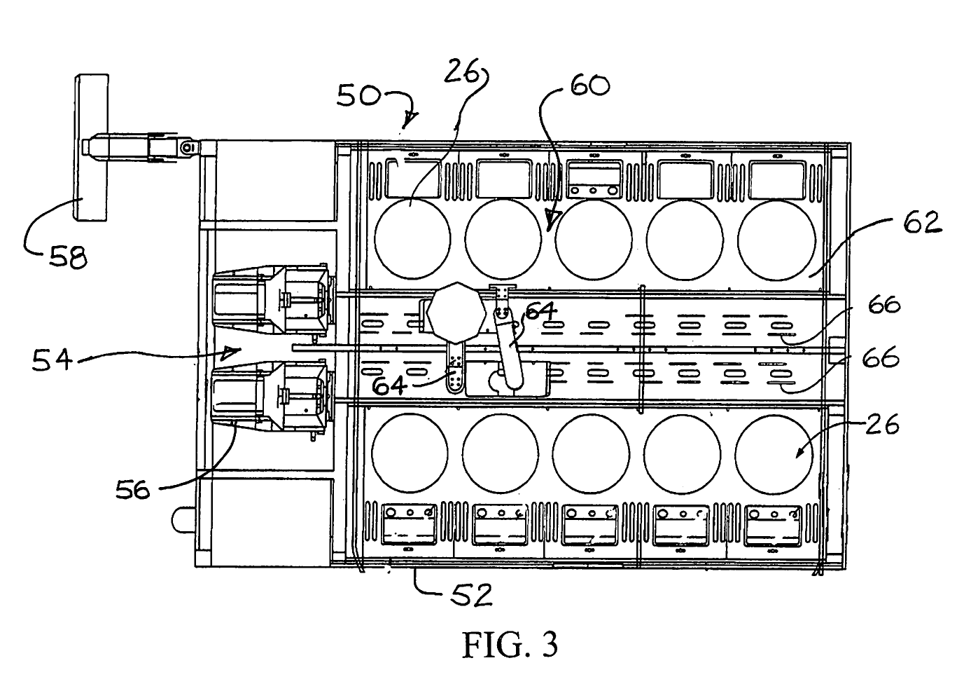

FIGS. 2 and 3 show an automated system 50 for performing the methods described above. As shown in FIG. 2, the system 50 has a load/unload station 54 at the front end of an enclosure 52. Containers 56 holding workpieces 30 are delivered to load/unload station 54 for processing within the system 50. A computer controller 58 controls and monitors operation of the system 50.

Referring to FIG. 3, process chambers 26 are provided in arrays on a deck 62 of a process section 60 of the system 50. One or more robots 64 move along pathways or tracks 66, to carry workpieces from the load/unload station to the process chambers, and then back to the load/unload station, after processing is complete. The liquid and gas supply elements shown in FIG. 1 may typically be located within the system 50, below the deck 62.

The concentrations of sulfuric acid described in the claims are concentrations using 96 weight % sulfuric acid as the starting material. The concentrations in ppm of HF in the claims are concentrations using 49 weight % HF concentration (of HF in water). Of course, starting materials having other concentrations may of course also be used, with the concentrations in the claims adjusted as appropriate to compensate for differences in the starting materials. The terms connected or connecting in the claims mean set up to move liquid or gas from one location to another, through a pipeline, tube, etc. The liquids and gases described above are typically stored in bulk, or manufactured, in the fab or factory, and are supplied to a processing apparatus via pipelines. Hence the apparatus used for performing the processes described ordinarily may not itself contain the process liquids and gases, but rather the apparatus, or process chamber, is supplied with process liquids and gases from external sources.

A workpiece, or microelectronic workpiece, is defined here to include a workpiece formed from a substrate upon which microelectronic circuits or components, data storage elements or layers, and/or micro-mechanical elements are formed. The apparatus and methods described here may be used to clean or process workpieces such as semiconductor wafers or articles, as well as other workpieces or objects such as flat panel displays, hard disk media, CD glass, memory media, optical media or masks, etc.

Thus, novel methods and solutions for removing post etch residue from aluminum surfaces on a substrate have been described. Various changes and substitutions may of course be made without departing from the spirit and scope of the invention. The invention, therefore, should not be limited, except by the following claims and their equivalents.

1. A method for removing residue from a workpiece, comprising:
preparing a liquid including de-ionized water, and sulfuric acid;
carbonating the liquid by introducing carbon dioxide gas into the liquid;
maintaining the liquid at a temperature of about 20-45 C;
applying the liquid onto a workpiece in a chamber, with the workpiece having aluminum or aluminum alloy features, with the liquid forming a liquid layer on the workpiece;
controlling the thickness of the liquid layer; and
introducing ozone gas into the chamber.

2. The method of claim 1 with the sulfuric acid comprising about 3-15% of the liquid by volume, and further comprising hydrofluoric acid, with the hydrofluoric acid comprising about 10-500 ppm by weight of the liquid.

3. The method of claim 2 with the sulfuric acid comprising about 6-8% of the liquid by volume, and with the hydrofluoric acid comprising about 20-300 ppm of the liquid.

4. The method of claim 1 with the ozone gas concentration in the chamber exceeding about 50 GNM3

5. The method of claim 1 further comprising spinning the workpiece in the chamber and spraying the liquid onto the workpiece.

6. The method of claim 5 further comprising spraying the ozone gas towards the liquid layer.

7. The method of claim 1 further comprising injecting the carbon dioxide gas into a supply line carrying the liquid to the chamber.

8. The method of claim 1 with the liquid saturated with carbon dioxide gas.

9. The method of claim 1 further comprising entraining ozone gas in the liquid.

10. The method of claim 1 further comprising maintaining the liquid on the workpiece, and maintaining the ozone in the chamber, for from about 20-300 seconds, and then rinsing the workpiece.

11. The method of claim 1 wherein the residue comprises post etch residue.

12. A method for removing residue from a workpiece, comprising:
preparing a liquid including de-ionized water, hydrofluoric acid, and carbon dioxide gas;
maintaining the liquid at a temperature of about 20-40° C.;
applying the liquid onto a workpiece in a chamber, with the workpiece having aluminum or aluminum alloy, or copper or copper alloy features.

13. The method of claim 12 where the volume ratio of de-ionized water to hydrofluoric acid is about from 2000:1 to about 500:1.

14. The method of claim 12 further comprising maintaining the liquid within 2° C. of a selected temperature.

15. The method of claim 12 with the carbon dioxide gas injected into the liquid.

16. Apparatus for processing a workpiece, comprising:
a process chamber;
a rotor in the process chamber for holding and rotating at least one workpiece;
one or more liquid outlets positioned to apply liquid to a workpiece on the rotor;
a liquid supply connected to the liquid outlets for supplying a liquid to the process chamber, with the liquid including deionized water, and sulfuric acid;
a carbon dioxide gas source associated with the liquid supply for introducing carbon dioxide gas into the liquid, to carbonate the liquid;
a liquid temperature controller associated with the liquid supply for controlling the temperature of the liquid; and
an ozone gas source, with at least one ozone gas delivery line connecting the ozone gas source to the process chamber.

17. The apparatus of claim 16 with the liquid outlets comprising liquid spray nozzles, and with the ozone gas delivery line connecting to a gas spray nozzle within the process chamber positioned to spray ozone gas onto a workpiece on the rotor.

18. The apparatus of claim 16 with the rotor adapted to hold a single workpiece and rotate about a substantially vertical axis.

19. The apparatus of claim 16 with the liquid supply supplying a liquid further comprising hydrofluoric acid.

20. A system for cleaning workpieces, comprising:
a load/unload section;
a process section including a plurality of process chambers, with one or more of the process chambers including a rotor for holding and rotating a workpiece, and one or more liquid outlets positioned to apply a process liquid onto a workpiece on the rotor;
a liquid supply source of de-ionized water, and hydrofluoric acid;
a liquid supply line connecting the liquid supply source of deionized water and hydrofluoric acid to the liquid outlets in the process chambers;
a carbon dioxide gas source connecting the liquid supply source or the liquid supply line, for introducing carbon dioxide gas into the liquid, before the liquid flows out of the outlets;
a liquid temperature controller associated with the liquid supply source or the liquid supply line, for controlling the temperature of the liquid; and
a robot moveable to carry workpieces between the load/unload section and to the plurality of process chambers.

21. The system of claim 20 with the liquid supply source further comprising sulfuric acid.

22. The system of claim 20 further comprising an ozone generator connecting to the process chambers.
